(19) United States
(12) Patent Application Publication
(10) Pub. No.: US 2024/0048232 A1
(43) Pub. Date: Feb. 8, 2024

(54) COVERAGE GAP MANAGEMENT FOR NON-TERRESTRIAL NETWORKS

(71) Applicant: QUALCOMM Incorporated, San Diego, CA (US)

(72) Inventors: Amer CATOVIC, San Diego, CA (US); Bharat SHRESTHA, San Diego, CA (US); Geetha Priya RAJENDRAN, Bangalore (IN); Prasad Reddy KADIRI, San Diego, CA (US); Stephen William EDGE, Escondido, CA (US)

(21) Appl. No.: 18/356,929

(22) Filed: Jul. 21, 2023

(30) Foreign Application Priority Data
Aug. 8, 2022 (IN) 202221045189

(51) Int. Cl. H04B 7/185

(52) U.S. Cl. CPC H04B 7/18519

(57) ABSTRACT

Various aspects of the present disclosure generally relate to wireless communication. In some aspects, a user equipment (UE) may access a serving network via a satellite while in a first state with the serving network, the first state comprising a connected state. The UE may transmit, to the serving network and based on a determination that a coverage gap associated with the satellite is upcoming, a coverage gap indication that indicates that the coverage gap is upcoming. The UE may transition from the connected state to a second state at or before a start of the coverage gap. Numerous other aspects are described.

### CROSS-REFERENCE TO RELATED APPLICATION

This Patent Application claims priority to Indian Provisional Patent Application No. 202221045189, filed on Aug. 8, 2022, entitled “COVERAGE GAP MANAGEMENT FOR NON-TERRESTRIAL NETWORKS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for coverage gap management for non-terrestrial networks.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to access a serving network via a satellite while in a first state with the serving network, the first state comprising a connected state. The one or more processors may be configured to transmit, to the serving network and based on a determination that a coverage gap associated with the satellite is upcoming, a coverage gap indication that indicates that the coverage gap is upcoming. The one or more processors may be configured to transition from the connected state to a second state at or before a start of the coverage gap.

Some aspects described herein relate to a network node for wireless communication. The network node may include one or more memories and one or more processors coupled to the one or more memories. The one or more processors may be configured to receive, from a UE while the UE is in a first state with the serving network, a coverage gap indication that indicates that a coverage gap associated with a satellite via which the UE accesses the serving network is upcoming, the first state comprising a connected state. The one or more processors may be configured to transition the UE to a second state at or before a start of the coverage gap.

Some aspects described herein relate to a method of wireless communication performed by a UE. The method may include accessing a serving network via a satellite while in a first state with the serving network, the first state comprising a connected state. The method may include transmitting, to the serving network and based on a determination that a coverage gap associated with the satellite is upcoming, a coverage gap indication that indicates that the coverage gap is upcoming. The method may include transitioning from the connected state to a second state at or before a start of the coverage gap.

Some aspects described herein relate to a method of wireless communication performed by a network node of a serving network. The method may include receiving, from a UE while the UE is in a first state with the serving network, a coverage gap indication that indicates that a coverage gap associated with a satellite via which the UE accesses the serving network is upcoming, the first state comprising a connected state. The method may include transitioning the UE to a second state at or before a start of the coverage gap.

Some aspects described herein relate to a non-transitory computer-readable medium that stores a set of instructions for wireless communication by a UE. The set of instructions, when executed by one or more processors of the UE, may cause the UE to access a serving network via a satellite while in a first state with the serving network, the first state comprising a connected state. The set of instructions, when executed by one or more processors of the UE, may cause the UE to transmit, to the serving network and based on a determination that a coverage gap associated with the satellite is upcoming, a coverage gap indication that indicates that the coverage gap is upcoming. The set of instructions, when executed by one or more processors of the UE, may cause the UE to transition from the connected state to a second state at or before a start of the coverage gap.

Some aspects described herein relate to a non-transitory computer-readable medium that stores a set of instructions for wireless communication by a network node.

The set of instructions, when executed by one or more processors of the network node, may cause the network node to receive, from a UE while the UE is in a first state with the serving network, a coverage gap indication that indicates that a coverage gap associated with a satellite via which the UE accesses the serving network is upcoming, the first state comprising a connected state. The set of instructions, when executed by one or more processors of the network node, may cause the network to transition the UE to a second state at or before a start of the coverage gap.

Some aspects described herein relate to an apparatus for wireless communication. The apparatus may include means for accessing a serving network via a satellite while in a first state with the serving network, the first state comprising a connected state. The apparatus may include means for transmitting, to a network node for the serving network and based on a determination that a coverage gap associated with the satellite is upcoming, a coverage gap indication that indicates that the coverage gap is upcoming. The apparatus may include means for transitioning from the connected state to a second state at or before a start of the coverage gap.

Some aspects described herein relate to an apparatus for wireless communication. The apparatus may include means for receiving, from a UE while the UE is in a first state with the network, a coverage gap indication that indicates that a coverage gap associated with a satellite via which the UE accesses the serving network is upcoming, the first state comprising a connected state. The apparatus may include means for transitioning the UE to a second state at or before a start of the coverage gap.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a wireless communications network including a non-terrestrial network (NTN) network node, in accordance with the present disclosure.

FIG. 5 is a diagram illustrating an example of NTN communications, in accordance with the present disclosure.

FIG. 6 is a diagram illustrating an example associated with coverage gap management for NTNs, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Aspects and examples generally include a method, apparatus, network node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component-based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

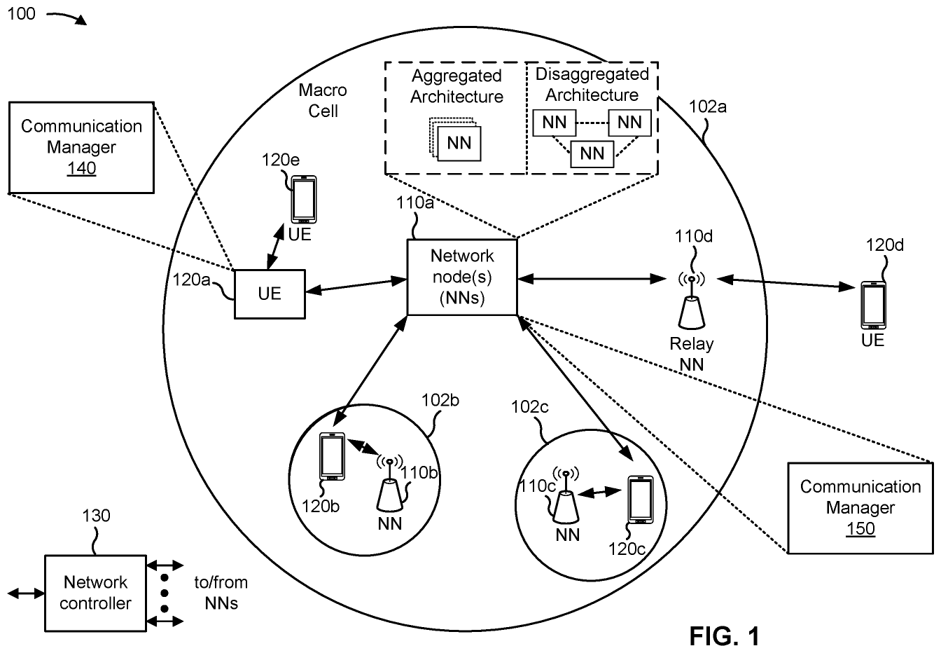

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

In some aspects, the wireless network 100 may include one or more non-terrestrial network (NTN) deployments in which a non-terrestrial wireless communication device may include a UE (referred to herein, interchangeably, as a “non-terrestrial UE”) and/or another network node (referred to herein, interchangeably, as a “non-terrestrial network node”). A non-terrestrial network node may include, for example, a base station (referred to herein, interchangeably, as a “non-terrestrial base station”) and/or a relay station (referred to herein, interchangeably, as a “non-terrestrial relay station”), among other examples. As used herein, “NTN” may refer to a network for which access is facilitated by a non-terrestrial UE and/or a non-terrestrial network node.

The wireless network 100 may include any number of non-terrestrial wireless communication devices. A non-terrestrial wireless communication device may include a satellite, a manned aircraft system, an unmanned aircraft system (UAS) platform, and/or the like. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, helicopter, and/or a dirigible, among other examples. A UAS platform may include a high-altitude platform station (HAPS), and may include a balloon, a dirigible, and/or an airplane, among other examples. A non-terrestrial wireless communication device may be part of an NTN that is separate from the wireless network 100. Alternatively, an NTN may be part of the wireless network 100. Satellites may communicate directly and/or indirectly with other entities in wireless network 100 using satellite communication. The other entities may include UEs (e.g., terrestrial UEs and/or non-terrestrial UEs), other satellites in the one or more NTN deployments, other types of network nodes (e.g., stationary and/or ground-based network nodes), relay stations, and/or one or more components and/or devices included in a core network of wireless network 100, among other examples.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may access a serving network via a satellite while in a first state with the serving network, the first state comprising a connected state; transmit, to the serving network and based on a determination that a coverage gap associated with the satellite is upcoming, a coverage gap indication that indicates that the coverage gap is upcoming; and transition from the connected state to a second state at or before a start of the coverage gap. Additionally, or alternatively, the communication manager 140 may perform one or more other operations described herein.

In some aspects, a network node (e.g., the network node 110) may include a communication manager 150. As described in more detail elsewhere herein, the communication manager 150 may receive, from a UE while the UE is in a first state with the serving network, a coverage gap indication that indicates that a coverage gap associated with a satellite via which the UE accesses the serving network is upcoming, the first state comprising a connected state; and transition the UE to a second state at or before a start of the coverage gap. Additionally, or alternatively, the communication manager 150 may perform one or more other operations described herein.

As indicated above, FIG. 1 is provided as an example. Other examples may differ from what is described with regard to FIG. 1.

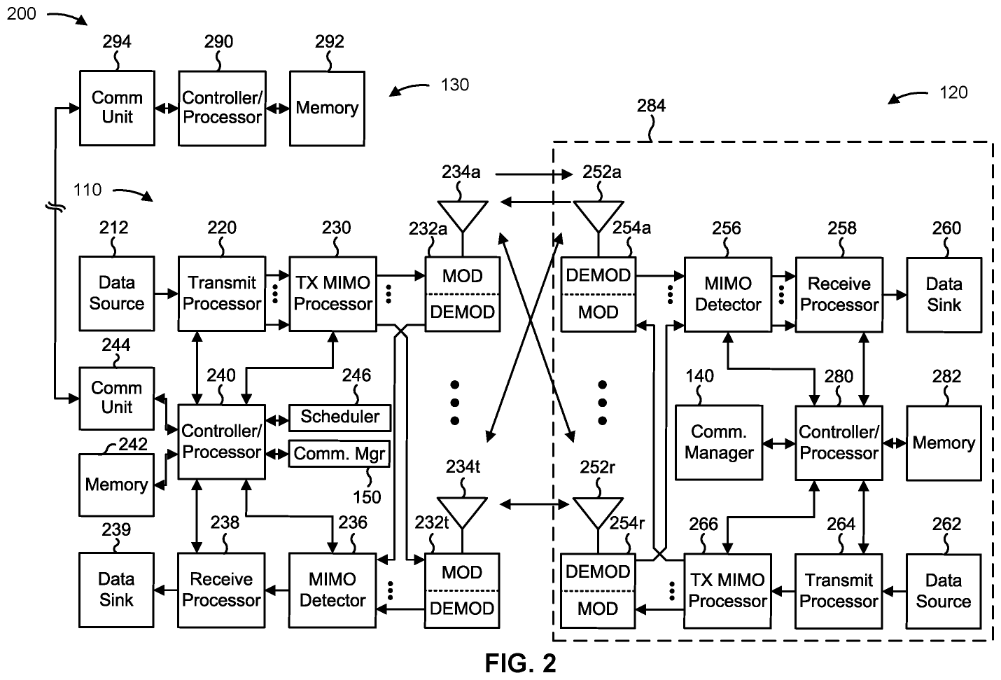

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCS s) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

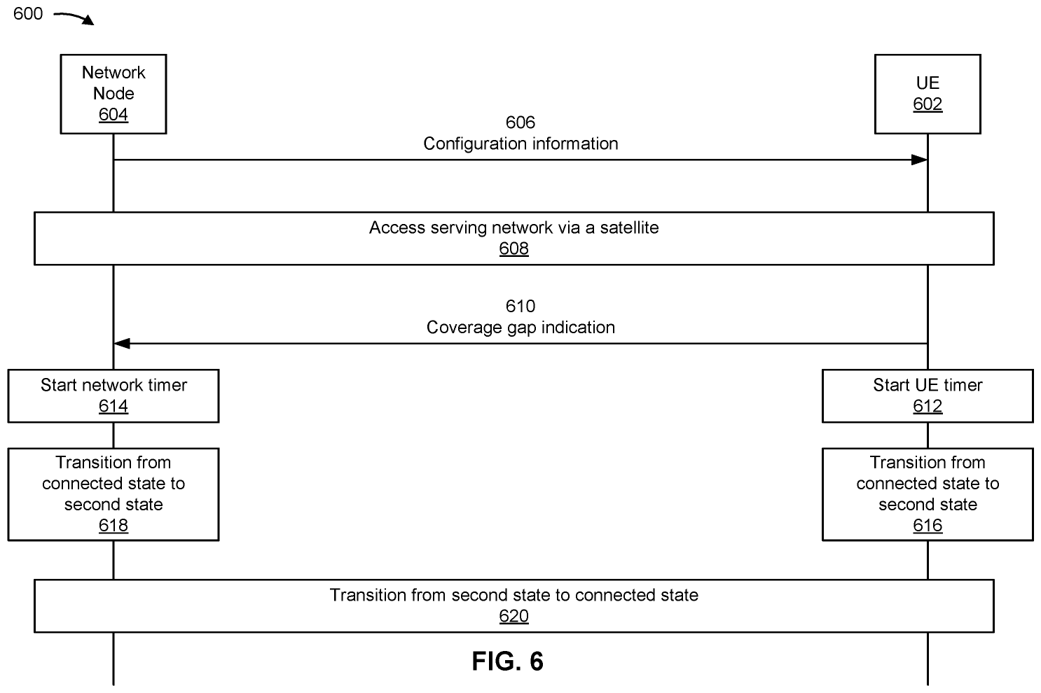

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-10).

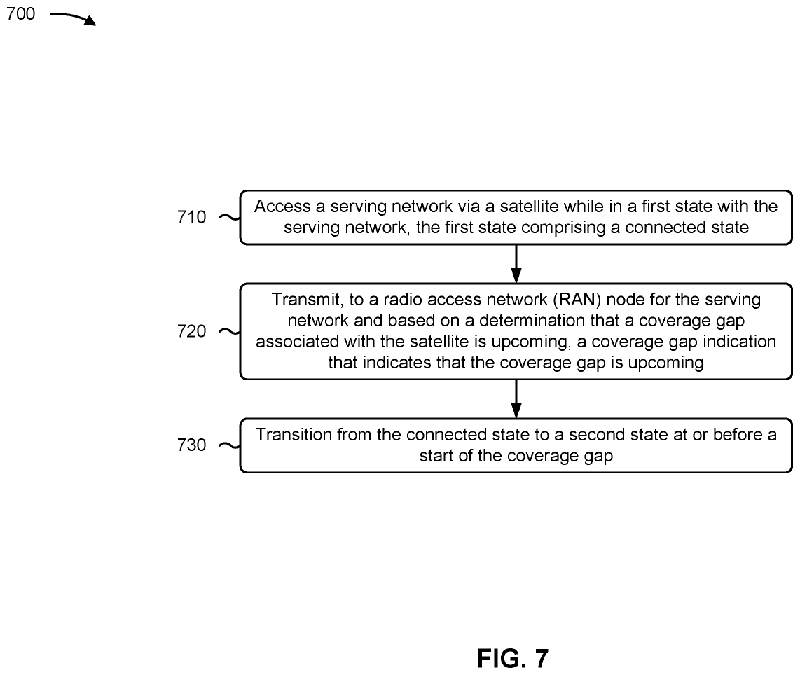

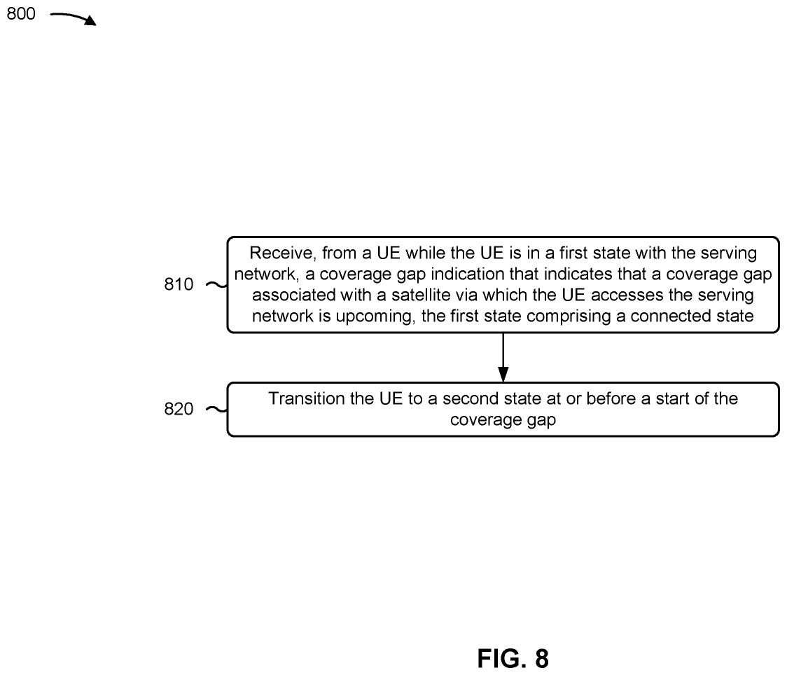

The controller/processor 240 of the network node 110, the controller/processor 280 of the UE 120, and/or any other component(s) of FIG. 2 may perform one or more techniques associated with coverage gap management for NTNs, as described in more detail elsewhere herein. In some aspects, the RAN node described herein is the network node 110, is included in the network node 110, or includes one or more components of the network node 110 shown in FIG. 2. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a UE (e.g., the UE 120) includes means for accessing a serving network via a satellite while in a first state with the serving network, the first state comprising a connected state; means for transmitting, to the serving network and based on a determination that a coverage gap associated with the satellite is upcoming, a coverage gap indication that indicates that the coverage gap is upcoming; and/or means for transitioning from the connected state to a second state at or before a start of the coverage gap. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from a UE while the UE is in a first state with the serving network, a coverage gap indication that indicates that a coverage gap associated with a satellite via which the UE accesses the serving network is upcoming, the first state comprising a connected state; and/or means for transitioning the UE to a second state at or before a start of the coverage gap. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

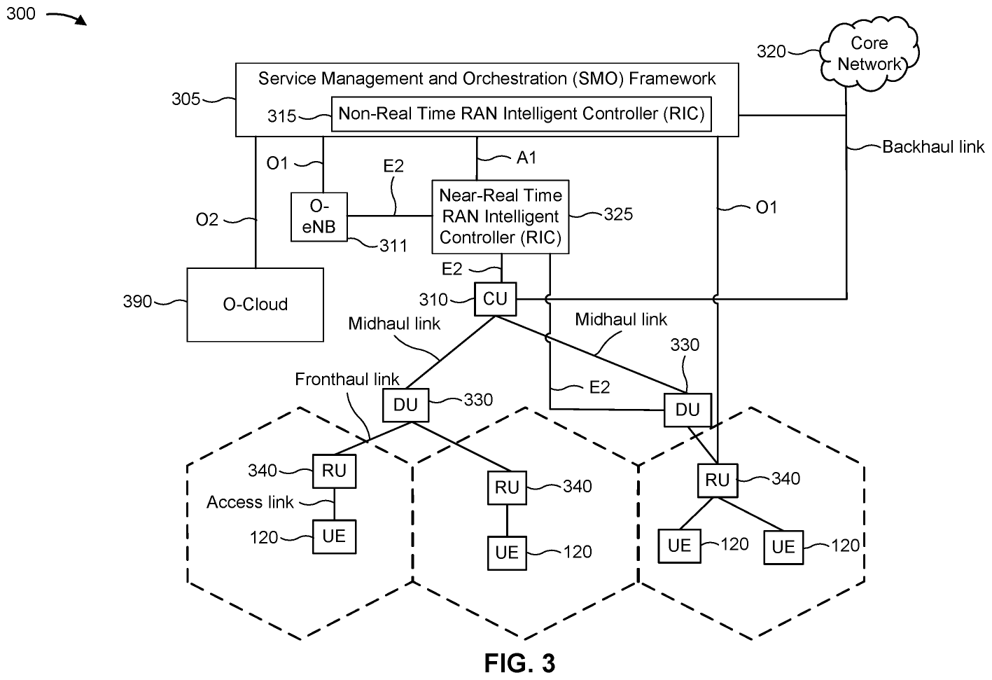

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective RF access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

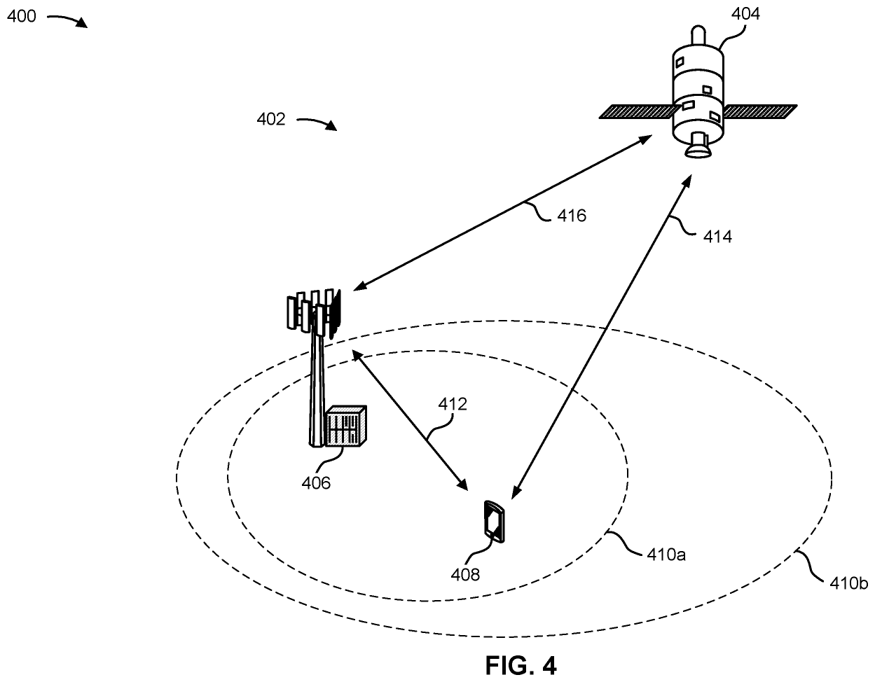

FIG. 4 is a diagram illustrating an example 400 of a wireless communications network 402 including an NTN network node 404, in accordance with the present disclosure. In some cases, the wireless communications network 402 may implement aspects of the wireless communication network 100. For example, the wireless communications network 402 may include a network node 406, a UE 408, and the non-terrestrial network entity 404, such as a satellite. The NTN network node 404 and/or the network node 406 may be, be similar to, include, or be included in, the network node 110 depicted in FIGS. 1 and 2 and/or one or more components of the disaggregate base station architecture 300 depicted in FIG. 3. The network node 406 may include, for example, a RAN node of a serving network and may serve a coverage area or cell 410a in cases of a terrestrial network, and non-terrestrial network entity 404 may serve the coverage area 410b in cases of an NTN. Some NTNs may employ airborne platforms (e.g., a balloon) and/or spaceborne platforms (e.g., a satellite), either of which may include the NTN network node 404. The UE 408 may be, be similar to, include, or be included in, the UE 120 depicted in FIGS. 1-3.

The NTN network node 404 may communicate with the network node 406 and the UE 408 as part of wireless communications in an NTN. In cases of a terrestrial network, the UE 408 may communicate with the network node 406 over a communication link 412. In the case of NTN wireless communications, the NTN network node 404 may provide a serving cell for the UE 408 via a communication link 414. In some cases, the NTN network node 404 may act as a relay (or a remote radio head) for the network node 404 and the UE 408. For example, the network node 404 may communicate with the NTN network node 404 via a communication link 416, and the NTN network node 404 may relay signaling between the network node 406 and UE 408 via the communication links 414 and 416.

As indicated above, FIG. 4 is provided as an example. Other examples may differ from what is described with respect to FIG. 4.

In some cases, an NTN network node may provide discontinuous radio coverage to a UE, for example, due to the orbits of NTN satellites. For example, some NTNs (such as LEO systems) can have one or more coverage gaps (which may also be known as response times or revisit times) in certain geographical areas. The coverage gap can be the duration between consecutive viewings (or coverage areas) of a given location for an NTN network node. As an example, a satellite revisit time (or coverage gap) could be 30 minutes to 12 hours, depending on the number of satellites deployed. As an example, the duration of the in-coverage time could be up to 5 minutes. The UE may be unreachable by the wireless network (such as the core network) during revisit time. During the coverage gap, the UE and/or network can attempt to reconnect or communicate with each other. Such operations during the coverage gap can be inefficient for power consumption, especially at the UE, and/or for signaling overhead (e.g., affecting spectral efficiency) at the RAN.

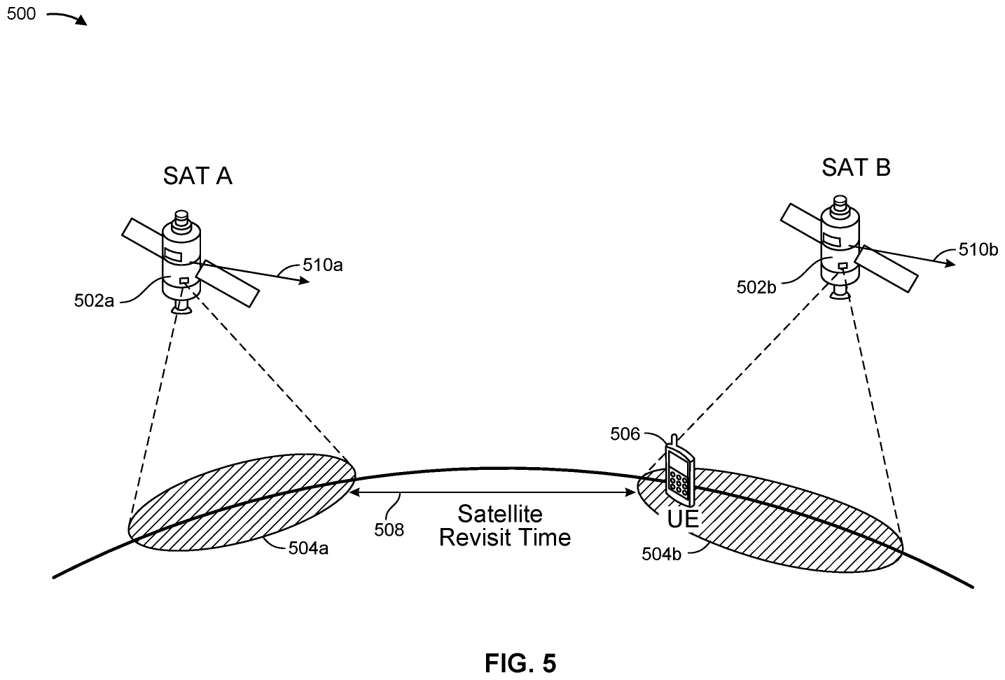

FIG. 5 is a diagram illustrating an example 500 of NTN communications, in accordance with the present disclosure. As shown, the NTN of example 500 includes two satellites 502a and 502b having coverage areas 504a and 504b, respectively. As shown, a UE 506 can be on the edge of the coverage area 504b of the second satellite 502b. A coverage gap 508 may occur between the coverage areas 504a and 504b of the satellites 502a and 502b. As the satellites 502a and 502b orbit generally in the respective directions 510a and 510b, respectively, the coverage areas 504a and 504b, as well as the coverage gap 508, pass over the UE 506, such that the UE 506 can experience discontinuous coverage with the NTN. When a UE (e.g., the UE 506) is in a coverage area (e.g., the coverage area 504a or 504b) of an NTN, the UE can be considered to be in an in-coverage state with the NTN, and when the UE is in the coverage gap (e.g., the coverage gap 508), the UE can be considered to be in an out-of-coverage state with the NTN for a certain duration (e.g., the time duration of the coverage gap 508).

Coverage gaps can present various issues in a wireless communication network. For example, when a UE is out-of-coverage with the NTN (e.g., when the UE is in a coverage gap), the wireless network (e.g., the core network) can be unaware of the coverage gap, and the wireless network can attempt to communicate with the UE while the UE is in the coverage gap of the NTN. For example, the core network can attempt to page the UE, and the core network can consider the non-responsiveness of the UE as one or more paging failures.

When a coverage gap occurs, the UE can lose the radio link, thereby triggering a radio link failure (RLF) detection procedure. After the RLF detection procedure, the UE can trigger an RLF recovery procedure. Since, during a coverage gap, the RLF recovery procedure would fail (due to persistent lack of coverage), the UE can declare itself to be in an out-of-service (OOS) state. In the OOS state, the UE can search for another network. This search can initially be resource- and power-intensive and, after a period of a lack of success, the search can progressively fade away. During a coverage gap, the network also can perform RLF detection, followed by an RLF recovery procedure (due to the coverage gap), which can be followed by the connection release by the network. Since the coverage gap can be predictable for the UE and can be persistent, refraining from attempting RLF detection and/or recovery upon the loss of a radio link due to a coverage gap can result in power savings at the UE. Additionally, since the radio link can be unrecoverable during the coverage gap, releasing the UE resources immediately rather than attempting to recover the radio link can result in power savings and reduced overhead from the network's perspective.

Aspects of the present disclosure provide techniques and apparatuses for coverage gap management for NTNs. In some aspects, a UE may access a serving network via a satellite while in a first state with the serving network. The first state may include a connected state. The UE may transmit, to a RAN node for the serving network and based on a determination that a coverage gap associated with the satellite is upcoming, a coverage gap indication that indicates that the coverage gap is upcoming. The UE may transition from the connected state to a second state at or before a start of the coverage gap. Additionally, the RAN node may transition the UE from the connected state to the second state. In some aspects, the second state may be a suspended state, an idle state, or an inactive state. In this way, some aspects may facilitate power savings at the UE (for example, due to initiating a power saving state at the UE during the coverage gap) and/or spectral efficiencies (for example, due to the UE locally transitioning to a second state in anticipation of the coverage gap).

As indicated above, FIG. 5 is provided as an example. Other examples may differ from what is described with respect to FIG. 5.

FIG. 6 is a diagram illustrating an example 600 associated with coverage gap management for NTNs, in accordance with the present disclosure. As shown in FIG. 6, a UE 602 and a network node 604 may communicate with one another. In some aspects, the UE 602 may be, be similar to, include, or be included in, the UE 506 depicted in FIG. 5, the UE 408 depicted in FIG. 4, and/or the UE 120 depicted in FIGS. 1-3. In some aspects, the network node 604 may be, be similar to, include, or be included in, the satellite 502a and/or 502b depicted in FIG. 5, the NTN network node 404 and/or the network node 406 depicted in FIG. 4, one or more aspects of the disaggregated base station architecture depicted in FIG. 3, and/or the network node 110 depicted in FIGS. 1 and 2. For example, in some aspects, the network node 604 may be a RAN node. In some aspects, the network node 604 may be a satellite-based node (e.g., a satellite-based RAN node). The network node 604 may be associated with a serving network. In some aspects, the network node 604 may be a core network node. For example, in some aspects, the network node 604 may include an access and mobility management function (AMF).

As shown by reference number 606, the network node 604 may transmit, and the UE 602 may receive, configuration information. In one aspect, the configuration information may be transmitted, for example, using RRC signaling. In another aspect, the configuration information may be transmitted via system information in a broadcast channel. The configuration information may indicate a coverage gap management procedure. The coverage gap management procedure may include one or more aspects described herein. For example, as part of a coverage gap management procedure, the UE 602 may determine that a coverage gap is upcoming, that the UE 602 may transmit a coverage gap indication to the network node 604 based on the determination that the coverage gap is upcoming, and that the UE 602 may transition from a connected state to a second state at or before the start of the coverage gap. In some aspects, the configuration information may indicate the second state. For example, the second state may include an idle state, a suspended state, or an inactive state. In some aspects, for example, the configuration information may be indicative of a suspended state configuration corresponding to the suspended state.

In some aspects, the configuration information may include a configuration support indication that indicates that the serving network supports receiving the coverage gap indication. In some aspects, the network node may advertise whether the indication is supported in system information in a broadcast channel. For example, the system information may include a binary flag or a Boolean flag that indicates whether the indication is supported.

In some aspects, the configuration information may include a UE timer configuration. In some aspects, the configuration information may indicate a value of the UE timer. In some aspects, the UE timer value provided by the serving network via the network node 604 may be included in the configuration information and may include a UE timer value, a UE timer range, or an indication of a selectable UE timer value. In some aspects, the signaling of the UE timer value may implicitly indicate that the network node 604 supports receiving the coverage gap indication.

As shown by reference number 608, the UE 602 may access a serving network via a satellite while in a first state with the serving network. The first state may include a connected state. As shown by reference number 610, the UE 602 may transmit, and the network node 604 may receive, a coverage gap indication. The UE 602 may transmit the coverage gap indication based on a determination that a coverage gap associated with the satellite is upcoming. The coverage gap indication may indicate that the coverage gap is upcoming.

In some aspects, the UE 602 may determine that a coverage gap associated with the satellite is upcoming based on the estimate of the time of the start of the next coverage gap. In some aspects, the UE 602 may generate the estimate of the time of the start of the next coverage gap associated with the satellite based on the information about the satellite constellation provided by the network. In some aspects, the information about the satellite constellation may include satellite ephemeris data. In some aspects, the satellite ephemeris data may be provided in the system information in a broadcast channel.

In some aspects, the UE 602 may determine that a coverage gap is upcoming based on determining that the UE 602 will not be scheduled or otherwise configured to communicate with the serving network via the satellite before the end of the coverage gap.

In some aspects, the UE 602 may transmit the coverage gap indication based on the configuration information. In some aspects, the UE 602 may transmit the coverage gap indication based on receiving an indication that indicates that the network node 604 supports receiving the coverage gap indication. In some aspects, the UE 602 may transmit the coverage gap indication based on transmitting a MAC layer communication that includes the coverage gap indication. The MAC layer communication may include a release assistance indication that includes the coverage gap indication. In some aspects, the UE 602 may transmit the coverage gap indication based on transmitting an RRC layer message that includes the coverage gap indication. In some aspects, the UE 602 may transmit the coverage gap indication based on transmitting a non-access stratum (NAS) layer message that includes the coverage gap indication. The coverage gap indication may include a release assistance indication.

As shown by reference number 612, the UE 602 may start a UE timer. The UE 602 may start the UE timer while transmitting the coverage gap indication or after transmitting the coverage gap indication. In some aspects, the configuration information may indicate that a value of the UE timer includes a value selected by the UE 602. In some aspects, the UE 602 may refrain from starting the UE timer based on the value selected by the UE 602 being equal to zero.

In some aspects, a duration of the UE timer may be set to one of a UE timer value provided by the serving network or a UE timer value selected by the UE 602. For example, in some aspects, the UE timer value provided by the serving network may be included in the configuration information and may include a UE timer value, a UE timer range, or an indication of a selectable UE timer value. In some aspects, a duration of the UE timer may be set to one of the UE timer value when the configuration information is indicative of the UE timer value, a value within the UE timer range when the configuration information is indicative of the UE timer range, or a value selected by the UE 602 when the configuration information is indicative of the selectable UE timer value or an indication that the UE timer value is zero. In some aspects, the UE timer value selected by the UE 602 may be equal to zero.

In some aspects, the UE 602 may transmit the coverage gap indication based on a difference between a duration of the UE timer and a time remaining until a start of the coverage gap associated with the satellite satisfying a threshold time value. In some aspects, the UE 602 may transmit, to the network node 604, an indication of a duration of the UE timer.

As shown by reference number 614, the network node 604 may start a network timer. The network timer may correspond to the UE timer, and the network node 604 may start the network timer based on receiving the coverage gap indication. In some aspects, the network node 604 may receive an indication of the UE timer value from the UE 602 and may set a network timer value of the network timer based on the UE timer value. In some aspects, if the network has not configured a UE timer for the UE 602, the network node 604 may start an implementation-specific network timer. The value of the implementation-specific network timer may be determined based on scheduling information and/or location information associated with the UE 602.

As shown by reference number 616, the UE 602 may transition from the connected state to a second state at or before a start of the coverage gap. In some aspects, the UE 602 may determine that the duration of the UE timer has expired or is set to zero and may transition from the connected state to the second state based on determining that the duration of the timer has expired or is set to zero. In some aspects, if the UE timer has a value equal to zero, the UE 602 may transition to the second state at any time (e.g. based on an implementation-specific UE timer value). In some aspects, the network node 604 may transmit, and the UE 602 may transition to the second state upon receiving a connection release command prior to an expiration of a duration of the UE timer.

In some aspects, the UE 602 may transition from the connected state to the second state based on suspending or inactivating a signaling connection between the UE and the network node. In some aspects, the second state may include a suspended state or an inactive state. In some aspects, the suspended state may include an idle state associated with a suspend indication. In some aspects, the inactive state may include a connected state to the serving network associated with an RRC inactive state.

In some aspects, the UE 602 may enter a power saving state based on transitioning from the connected state to the second state. Entering the power saving state may include deactivating at least one of a transceiver function, a network search function, or a paging monitoring function.

As shown by reference number 618, the network node 604 may transition the UE 602 to a second state at or before a start of the coverage gap. In some aspects, transitioning the UE 602 from the connected state to the second state may include suspending or inactivating a signaling connection between the UE 602 and the network node 604. As indicated above, the second state may include a suspended state, an idle state, or an inactive state. In some aspects, the network node 604 may determine that a duration of the network timer has expired or is set to zero and may release a signalling connection between the network node 604 and the UE 602 based on determining that the duration of the network timer has expired or is set to zero.

As shown by reference number 620, the UE 602 and the network node 604 may transition from the second state to a connected state. For example, the UE 602 may transition, based on a resume procedure, from the second state to the connected state based on a determination of an end of the coverage gap. The network node 604 may transition the UE 602, based on the resume procedure, from the second state to the connected state based on a determination of an end of the coverage gap.

As indicated above, FIG. 6 is provided as an example. Other examples may differ from what is described with respect to FIG. 6.

FIG. 7 is a diagram illustrating an example process 700 performed, for example, by a UE, in accordance with the present disclosure. Example process 700 is an example where the UE (e.g., UE 602) performs operations associated with coverage gap management for NTNs.

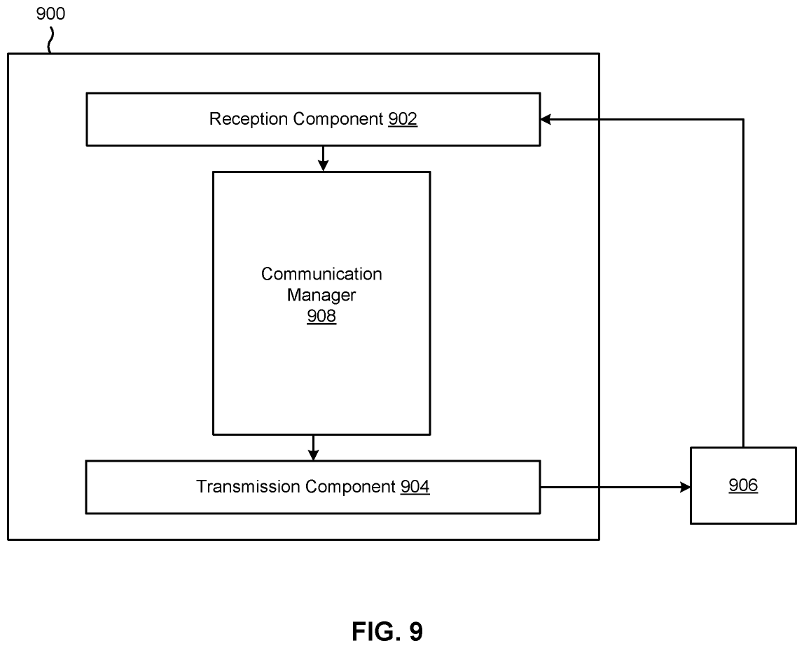

As shown in FIG. 7, in some aspects, process 700 may include accessing a serving network via a satellite while in a first state with the serving network, the first state comprising a connected state (block 710). For example, the UE (e.g., using communication manager 908, reception component 902, and/or transmission component 904, depicted in FIG. 9) may access a serving network via a satellite while in a first state with the serving network, the first state comprising a connected state, as described above.

As further shown in FIG. 7, in some aspects, process 700 may include transmitting, to a RAN node for the serving network and based on a determination that a coverage gap associated with the satellite is upcoming, a coverage gap indication that indicates that the coverage gap is upcoming (block 720). For example, the UE (e.g., using communication manager 908 and/or transmission component 904, depicted in FIG. 9) may transmit, to a RAN node for the serving network and based on a determination that a coverage gap associated with the satellite is upcoming, a coverage gap indication that indicates that the coverage gap is upcoming, as described above.

In some aspects, the RAN node comprises a satellite-based node. In some aspects, transmitting the coverage gap indication to the serving network comprises transmitting the coverage gap indication to a core network node of the serving network. In some aspects, the core network node may include an AMF. In some aspects, transmitting the coverage gap indication comprises transmitting a MAC layer communication that includes the coverage gap indication. In some aspects, the MAC layer communication comprises a release assistance indication that includes the coverage gap indication. In some aspects, transmitting the coverage gap indication comprises transmitting an RRC layer message that includes the coverage gap indication. In some aspects, transmitting the coverage gap indication comprises transmitting an NAS layer message and the coverage gap indication. In some aspects, the coverage gap indication comprises a release assistance indication.

As further shown in FIG. 7, in some aspects, process 700 may include transitioning from the connected state to a second state at or before a start of the coverage gap (block 730). For example, the UE (e.g., using communication manager 908, depicted in FIG. 9) may transition from the connected state to a second state at or before a start of the coverage gap, as described above.

In some aspects, the second state comprises an idle state, a suspended state, or an inactive state. In some aspects, process 700 includes entering a power saving state based on transitioning from the connected state to the second state. In some aspects, entering the power saving state comprises deactivating at least one of a transceiver function, a network search function, or a paging monitoring function. In some aspects, transitioning from the connected state to the second state comprises suspending or inactivating a signaling connection between the UE and the RAN node. In some aspects, the second state comprises a suspended state or an inactive state. In some aspects, the suspended state comprises an idle state associated with a suspend indication. In some aspects, the inactive state comprises a connected state to the serving network associated with an RRC inactive state. In some aspects, process 700 includes receiving configuration information indicative of a suspended state configuration corresponding to the suspended state. In some aspects, process 700 includes transitioning, based on a resume procedure, from the second state to the connected state based on a determination of an end of the coverage gap.

Process 700 may include additional aspects, such as any single aspect or any combination of aspects described below and/or in connection with one or more other processes described elsewhere herein.

In some aspects, process 700 includes receiving configuration information, wherein transmitting the coverage gap indication comprises transmitting the coverage gap indication based on receiving the configuration information. In some aspects, the configuration information comprises a configuration support indication that indicates that the serving network supports receiving the coverage gap indication.

In some aspects, the configuration information indicates that a value of a UE timer comprises a value selected by the UE, and wherein the value selected by the UE is equal to zero, the method further comprising refraining from starting the UE timer based on the value selected by the UE being equal to zero. In some aspects, process 700 includes starting a UE timer while transmitting the coverage gap indication or after transmitting the coverage gap indication. In some aspects, a duration of the UE timer is set to one of a UE timer value provided by the serving network or a timer value selected by the UE. In some aspects, the UE timer value provided by the serving network is included in the configuration information and comprises a UE timer value, a UE timer range, or an indication of a selectable UE timer value. In some aspects, a duration of the UE timer is set to one of the UE timer value when the configuration information is indicative of the UE timer value, a value within the timer range when the configuration information is indicative of the UE timer range, or a value selected by the UE when the configuration information is indicative of the selectable UE timer value or an indication that the timer value is zero. In some aspects, the UE timer value selected by the UE is equal to zero. In some aspects, process 700 includes determining that the duration of the UE timer has expired or is set to zero, wherein transitioning from the connected state to the second state comprises transitioning from the connected state to the second state based on determining that the duration of the UE timer has expired or is set to zero. In some aspects, process 700 includes transmitting the coverage gap indication based on a difference between a duration of the UE timer and a time remaining until a start of the coverage gap associated with the satellite satisfying a threshold time value. In some aspects, process 700 includes transmitting, to the RAN node, an indication of a duration of the UE timer. In some aspects, process 700 includes receiving a connection release command prior to an expiration of a duration of the UE timer. In some aspects, the configuration information indicates the second state.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a RAN node, in accordance with the present disclosure. Example process 800 is an example where the RAN node (e.g., RAN node 604) performs operations associated with coverage gap management for NTNs. In some aspects, the RAN node comprises a satellite-based node.

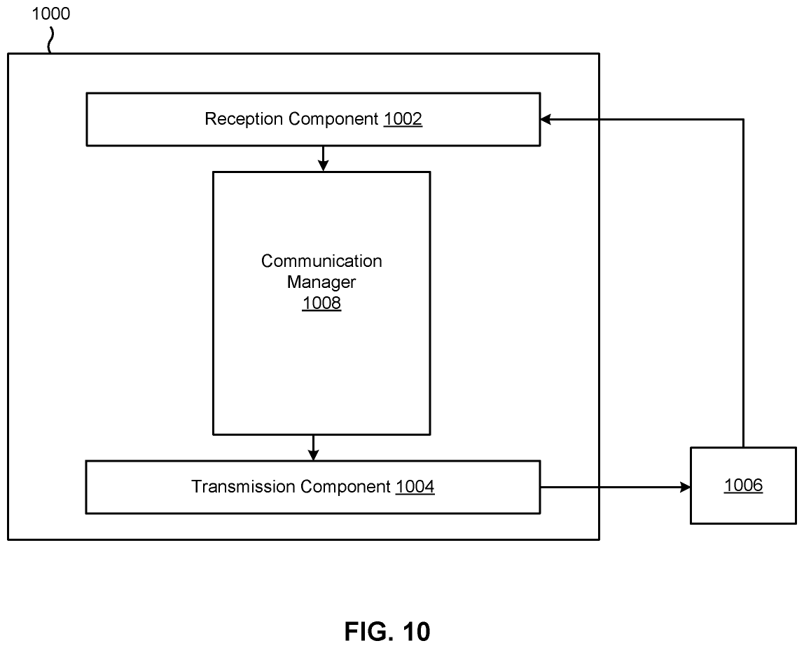

As shown in FIG. 8, in some aspects, process 800 may include receiving, from a UE while the UE is in a first state with the serving network, a coverage gap indication that indicates that a coverage gap associated with a satellite via which the UE accesses the serving network is upcoming, the first state comprising a connected state (block 810). For example, the RAN node (e.g., using communication manager 1008 and/or reception component 1002, depicted in FIG. 10) may receive, from a UE while the UE is in a first state with the serving network, a coverage gap indication that indicates that a coverage gap associated with a satellite via which the UE accesses the serving network is upcoming, the first state comprising a connected state, as described above.

In some aspects, receiving the coverage gap indication comprises receiving a MAC layer communication that includes the coverage gap indication. In some aspects, the MAC layer communication comprises a release assistance indication that includes the coverage gap indication. In some aspects, receiving the coverage gap indication comprises receiving an RRC layer message that includes the coverage gap indication. In some aspects, receiving the coverage gap indication comprises receiving an NAS layer message and the coverage gap indication. In some aspects, the coverage gap indication comprises a release assistance indication.

As further shown in FIG. 8, in some aspects, process 800 may include transitioning the UE to a second state at or before a start of the coverage gap (block 820). For example, the RAN node (e.g., using communication manager 1008 and/or transmission component 1004, depicted in FIG. 10) may transition the UE to a second state at or before a start of the coverage gap, as described above.

In some aspects, the second state comprises an idle state, a suspended state, or an inactive state. In some aspects, transitioning the UE from the connected state to the second state comprises suspending or inactivating a signaling connection between the UE and the RAN node. In some aspects, the second state comprises a suspended state or an inactive state. In some aspects, the suspended state comprises an idle state associated with a suspend indication. In some aspects, the inactive state comprises a connected state to the serving network associated with an RRC inactive state. In some aspects, process 800 includes transmitting configuration information indicative of a suspended state configuration corresponding to the suspended state. In some aspects, process 800 includes transitioning the UE, based on a resume procedure, from the second state to the connected state based on a determination of an end of the coverage gap.

Process 800 may include additional aspects, such as any single aspect or any combination of aspects described below and/or in connection with one or more other processes described elsewhere herein.

In some aspects, process 800 includes transmitting configuration information, wherein receiving the coverage gap indication comprises receiving the coverage gap indication based on the configuration information. In some aspects, the configuration information comprises a configuration support indication that indicates that the serving network supports receiving the coverage gap indication. In some aspects, the configuration information is indicative of a UE timer, wherein a duration of the UE timer is set to one of a UE timer value provided by the serving network or a UE timer value selected by the UE. In some aspects, a network timer corresponds to the UE timer, the method further comprising starting the network timer based on receiving the coverage gap indication. In some aspects, the UE timer value provided by the serving network is included in the configuration information and comprises a UE timer value, a UE timer range, or an indication of a selectable UE timer value. In some aspects, a duration of the UE timer is set to one of the UE timer value when the configuration information is indicative of the UE timer value, a value within the UE timer range when the configuration information is indicative of the UE timer range, or a value selected by the UE when the configuration information is indicative of the selectable UE timer value or an indication that the UE timer value is zero. In some aspects, the UE timer value selected by the UE is equal to zero. In some aspects, process 800 includes receiving the coverage gap indication based on a difference between a duration of the UE timer and a time remaining until a start of the coverage gap associated with the satellite satisfying a threshold time value. In some aspects, process 800 includes receiving, from the UE, an indication of the UE timer value, and setting a network timer value based on the UE timer value. In some aspects, process 800 includes transmitting a connection release command prior to an expiration of a duration of the UE timer. In some aspects, the configuration information indicates the second state. In some aspects, process 800 includes starting a network timer based on receiving the coverage gap indication. In some aspects, process 800 includes determining that a duration of the network timer has expired or is set to zero, and releasing a signalling connection between the RAN node and the UE based on determining that the duration of the network timer has expired or is set to zero.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902 and a transmission component 904, which may be in communication with one another (for example, via one or more buses and/or one or more other components). As shown, the apparatus 900 may communicate with another apparatus 906 (such as a UE, a base station, or another wireless communication device) using the reception component 902 and the transmission component 904. As further shown, the apparatus 900 may include a communication manager 908.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 906. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 906. In some aspects, one or more other components of the apparatus 900 may generate communications and may provide the generated communications to the transmission component 904 for transmission to the apparatus 906. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 906. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 908, the reception component 902, and/or the transmission component 904 may access a serving network via a satellite while in a first state with the serving network, the first state comprising a connected state. In some aspects, the communication manager 908 may include one or more antennas, a modem, a controller/processor, a memory, or a combination thereof, of the UE described in connection with FIG. 2. In some aspects, the communication manager 908 may include the reception component 902 and/or the transmission component 904. In some aspects, the communication manager 908 may be, be similar to, include, or be included in, the communication manager 140 depicted in FIGS. 1 and 2.

The communication manager 908 and/or the transmission component 904 may transmit, to a RAN node for the serving network and based on a determination that a coverage gap associated with the satellite is upcoming, a coverage gap indication that indicates that the coverage gap is upcoming. The communication manager 908 may transition from the connected state to a second state at or before a start of the coverage gap.

The communication manager 908 and/or the reception component 902 may receive configuration information, wherein transmitting the coverage gap indication comprises transmitting the coverage gap indication based on receiving the configuration information. The communication manager 908 may start a UE timer while transmitting the coverage gap indication or after transmitting the coverage gap indication. The communication manager 908 may determine that the duration of the UE timer has expired or is set to zero, wherein transitioning from the connected state to the second state comprises transitioning from the connected state to the second state based on determining that the duration of the UE timer has expired or is set to zero. The communication manager 908 and/or the transmission component 904 may transmit the coverage gap indication based on a difference between a duration of the UE timer and a time remaining until a start of the coverage gap associated with the satellite satisfying a threshold time value. The communication manager 908 and/or the transmission component 904 may transmit, to the RAN node, an indication of a duration of the UE timer. The communication manager 908 and/or the reception component 902 may receive a connection release command prior to an expiration of a duration of the UE timer. The communication manager 908 may enter a power saving state based on transitioning from the connected state to the second state. The communication manager 908 and/or the reception component 902 may receive configuration information indicative of a suspended state configuration corresponding to the suspended state. The communication manager 908 may transition, based on a resume procedure, from the second state to the connected state based on a determination of an end of the coverage gap.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a RAN node, or a RAN node may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include a communication manager 1008.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1008 and/or the reception component 1002 may receive, from a UE while the UE is in a first state with the serving network, a coverage gap indication that indicates that a coverage gap associated with a satellite via which the UE accesses the serving network is upcoming, the first state comprising a connected state. In some aspects, the communication manager 1008 may include one or more antennas, a modem, a controller/processor, a memory, or a combination thereof, of the network node described in connection with FIG. 2. In some aspects, the communication manager 1008 may include the reception component 1002 and/or the transmission component 1004. In some aspects, the communication manager 1008 may be, be similar to, include, or be included in, the communication manager 150 depicted in FIGS. 1 and 2.

The communication manager 1008 may transition the UE to a second state at or before a start of the coverage gap. The communication manager 1008 and/or the transmission component 1004 may transmit configuration information, wherein receiving the coverage gap indication comprises receiving the coverage gap indication based on the configuration information. The communication manager 1008 and/or the reception component 1002 may receive the coverage gap indication based on a difference between a duration of the UE timer and a time remaining until a start of the coverage gap associated with the satellite satisfying a threshold time value. The communication manager 1008 and/or the reception component 1002 may receive, from the UE, an indication of the UE timer value. The communication manager 1008 may set a network timer value based on the UE timer value.

The communication manager 1008 and/or the transmission component 1004 may transmit a connection release command prior to an expiration of a duration of the UE timer. The communication manager 1008 may start a network timer based on receiving the coverage gap indication. The communication manager 1008 may determine that a duration of the network timer has expired or is set to zero. The communication manager 1008 may release a signalling connection between the RAN node and the UE based on determining that the duration of the network timer has expired or is set to zero. The communication manager 1008 and/or the transmission component 1004 may transmit configuration information indicative of a suspended state configuration corresponding to the suspended state. The communication manager 1008 and/or transmission component 1004 may transition the UE, based on a resume procedure, from the second state to the connected state based on a determination of an end of the coverage gap.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: accessing a serving network via a satellite while in a first state with the serving network, the first state comprising a connected state; transmitting, to a radio access network (RAN) node for the serving network and based on a determination that a coverage gap associated with the satellite is upcoming, a coverage gap indication that indicates that the coverage gap is upcoming; and transitioning from the connected state to a second state at or before a start of the coverage gap.

Aspect 2: The method of Aspect 1, wherein the RAN node comprises a satellite-based node.

Aspect 3: The method of either of Aspects 1 or 2, further comprising receiving configuration information, wherein transmitting the coverage gap indication comprises transmitting the coverage gap indication based on receiving the configuration information.

Aspect 4: The method of Aspect 3, wherein the configuration information comprises a configuration support indication that indicates that the serving network supports receiving the coverage gap indication.

Aspect 5: The method of either of Aspects 3 or 4, wherein the configuration information indicates that a value of a UE timer comprises a value selected by the UE, and wherein the value selected by the UE is equal to zero, the method further comprising refraining from starting the UE timer based on the value selected by the UE being equal to zero.

Aspect 6: The method of any of Aspects 3-5, further comprising starting a UE timer while transmitting the coverage gap indication or after transmitting the coverage gap indication.

Aspect 7: The method of Aspect 6, wherein a duration of the UE timer is set to one of a UE timer value provided by the serving network or a UE timer value selected by the UE.

Aspect 8: The method of Aspect 7, wherein the UE timer value provided by the serving network is included in the configuration information and comprises a UE timer value, a UE timer range, or an indication of a selectable UE timer value.

Aspect 9: The method of Aspect 8, wherein a duration of the timer is set to one of the UE timer value when the configuration information is indicative of the UE timer value, a value within the UE timer range when the configuration information is indicative of the UE timer range, or a value selected by the UE when the configuration information is indicative of the selectable UE timer value or an indication that the UE timer value is zero.

Aspect 10: The method of Aspect 9, wherein the UE timer value selected by the UE is equal to zero.

Aspect 11: The method of either of Aspects 9 or 10, further comprising determining that the duration of the UE timer has expired or is set to zero, wherein transitioning from the connected state to the second state comprises transitioning from the connected state to the second state based on determining that the duration of the UE timer has expired or is set to zero.

Aspect 12: The method of any of Aspects 6-11, further comprising transmitting the coverage gap indication based on a difference between a duration of the UE timer and a time remaining until a start of the coverage gap associated with the satellite satisfying a threshold time value.

Aspect 13: The method of any of Aspects 6-12, further comprising transmitting to the RAN node an indication of a duration of the UE timer.

Aspect 14: The method of any of Aspects 6-13, further comprising receiving a connection release command prior to an expiration of a duration of the UE timer.

Aspect 15: The method of any of Aspects 3-14, wherein the configuration information indicates the second state.

Aspect 16: The method of any of Aspects 1-15, wherein transmitting the coverage gap indication comprises transmitting a medium access control (MAC) layer communication that includes the coverage gap indication.

Aspect 17: The method of Aspect 16, wherein the MAC layer communication comprises a release assistance indication that includes the coverage gap indication.

Aspect 18: The method of any of Aspects 1-17, wherein transmitting the coverage gap indication comprises transmitting a radio resource control (RRC) layer message that includes the coverage gap indication.

Aspect 19: The method of any of Aspects 1-18, wherein transmitting the coverage gap indication comprises transmitting a non-access stratum (NAS) layer message and the coverage gap indication.

Aspect 20: The method of any of Aspects 1-19, wherein the coverage gap indication comprises a release assistance indication.

Aspect 21: The method of any of Aspects 1-20, wherein the second state comprises an idle state, a suspended state, or an inactive state.

Aspect 22: The method of any of Aspects 1-21, further comprising entering a power saving state based on transitioning from the connected state to the second state.

Aspect 23: The method of Aspect 21, wherein entering the power saving state comprises deactivating at least one of a transceiver function, a network search function, or a paging monitoring function.

Aspect 24: The method of any of Aspects 1-23, wherein transitioning from the connected state to the second state comprises suspending or inactivating a signaling connection between the UE and the RAN node.

Aspect 25: The method of Aspect 24, wherein the second state comprises a suspended state or an inactive state.

Aspect 26: The method of Aspect 25, wherein the suspended state comprises an idle state associated with a suspend indication.

Aspect 27: The method of either of Aspects 25 or 26, wherein the inactive state comprises a connected state to the serving network associated with a radio resource control inactive state.

Aspect 28: The method of any of Aspects 25-27, further comprising receiving configuration information indicative of a suspended state configuration corresponding to the suspended state.

Aspect 29: The method of any of Aspects 24-28, further comprising transitioning, based on a resume procedure, from the second state to the connected state based on a determination of an end of the coverage gap.

Aspect 30: A method of wireless communication performed by a radio access network (RAN) node of a serving network, comprising: receiving, from a user equipment (UE) while the UE is in a first state with the serving network, a coverage gap indication that indicates that a coverage gap associated with a satellite via which the UE accesses the serving network is upcoming, the first state comprising a connected state; and transitioning the UE to a second state at or before a start of the coverage gap.

Aspect 31: The method of Aspect 30, wherein the RAN node comprises a satellite-based node.

Aspect 32: The method of either of Aspects 30 or 31, further comprising transmitting configuration information, wherein receiving the coverage gap indication comprises receiving the coverage gap indication based on the configuration information.

Aspect 33: The method of Aspect 32, wherein the configuration information comprises a configuration support indication that indicates that the serving network supports receiving the coverage gap indication.

Aspect 34: The method of either of Aspects 32 or 33, wherein the configuration information is indicative of a UE timer, wherein a duration of the UE timer is set to one of a UE timer value provided by the serving network or a UE timer value selected by the UE.

Aspect 35: The method of Aspect 34, wherein a network timer corresponds to the UE timer, the method further comprising starting the network timer based on receiving the coverage gap indication.

Aspect 36: The method of either of Aspects 34 or 35, wherein the UE timer value provided by the serving network is included in the configuration information and comprises a UE timer value, a UE timer range, or an indication of a selectable UE timer value.

Aspect 37: The method of any of Aspects 34-36, wherein a duration of the UE timer is set to one of the UE timer value when the configuration information is indicative of the UE timer value, a value within the UE timer range when the configuration information is indicative of the UE timer range, or a value selected by the UE when the configuration information is indicative of the selectable UE timer value or an indication that the UE timer value is zero.

Aspect 38: The method of Aspect 37, wherein the UE timer value selected by the UE is equal to zero.

Aspect 39: The method of any of Aspects 34-38, further comprising receiving the coverage gap indication based on a difference between a duration of the UE timer and a time remaining until a start of the coverage gap associated with the satellite satisfying a threshold time value.

Aspect 40: The method of any of Aspects 34-39, further comprising: receiving, from the UE, an indication of the UE timer value; and setting a network timer value based on the UE timer value.

Aspect 41: The method of any of Aspects 34-40, further comprising transmitting a connection release command prior to an expiration of a duration of the UE timer.

Aspect 42: The method of any of Aspects 32-41, wherein the configuration information indicates the second state.

Aspect 43: The method of any of Aspects 30-42, further comprising starting a network timer based on receiving the coverage gap indication.

Aspect 44: The method of Aspect 43, further comprising: determining that a duration of the network timer has expired or is set to zero; and releasing a signalling connection between the RAN node and the UE based on determining that the duration of the network timer has expired or is set to zero.

Aspect 45: The method of any of Aspects 30-44, wherein receiving the coverage gap indication comprises receiving a medium access control (MAC) layer communication that includes the coverage gap indication.

Aspect 46: The method of Aspect 45, wherein the MAC layer communication comprises a release assistance indication that includes the coverage gap indication.

Aspect 47: The method of any of Aspects 30-46, wherein receiving the coverage gap indication comprises receiving a radio resource control (RRC) layer message that includes the coverage gap indication.

Aspect 48: The method of any of Aspects 30-47, wherein receiving the coverage gap indication comprises receiving a non-access stratum (NAS) layer message and the coverage gap indication.

Aspect 49: The method of any of Aspects 30-48, wherein the coverage gap indication comprises a release assistance indication.

Aspect 50: The method of any of Aspects 30-49, wherein the second state comprises an idle state, a suspended state, or an inactive state.

Aspect 51: The method of any of Aspects 30-50, wherein transitioning the UE from the connected state to the second state comprises suspending or inactivating a signaling connection between the UE and the RAN node.

Aspect 52: The method of Aspect 51, wherein the second state comprises a suspended state or an inactive state.

Aspect 53: The method of Aspect 52, wherein the suspended state comprises an idle state associated with a suspend indication.

Aspect 54: The method of either of Aspects 52 or 53, wherein the inactive state comprises a connected state to the serving network associated with a radio resource control inactive state.

Aspect 55: The method of any of Aspects 52-54, further comprising transmitting configuration information indicative of a suspended state configuration corresponding to the suspended state.

Aspect 56: The method of any of Aspects 52-55, further comprising transitioning the UE, based on a resume procedure, from the second state to the connected state based on a determination of an end of the coverage gap.

Aspect 57: An apparatus for wireless communication at a device, comprising a processor; memory coupled with the processor; and instructions stored in the memory and executable by the processor to cause the apparatus to perform the method of one or more of Aspects 1-29.

Aspect 58: A device for wireless communication, comprising a memory and one or more processors coupled to the memory, the one or more processors configured to perform the method of one or more of Aspects 1-29.

Aspect 59: An apparatus for wireless communication, comprising at least one means for performing the method of one or more of Aspects 1-29.

Aspect 60: A non-transitory computer-readable medium storing code for wireless communication, the code comprising instructions executable by a processor to perform the method of one or more of Aspects 1-29.

Aspect 61: A non-transitory computer-readable medium storing a set of instructions for wireless communication, the set of instructions comprising one or more instructions that, when executed by one or more processors of a device, cause the device to perform the method of one or more of Aspects 1-29.

Aspect 62: An apparatus for wireless communication at a device, comprising a processor; memory coupled with the processor; and instructions stored in the memory and executable by the processor to cause the apparatus to perform the method of one or more of Aspects 30-56.

Aspect 63: A device for wireless communication, comprising a memory and one or more processors coupled to the memory, the one or more processors configured to perform the method of one or more of Aspects 30-56.

Aspect 64: An apparatus for wireless communication, comprising at least one means for performing the method of one or more of Aspects 30-56.

Aspect 65: A non-transitory computer-readable medium storing code for wireless communication, the code comprising instructions executable by a processor to perform the method of one or more of Aspects 30-56.

Aspect 66: A non-transitory computer-readable medium storing a set of instructions for wireless communication, the set of instructions comprising one or more instructions that, when executed by one or more processors of a device, cause the device to perform the method of one or more of Aspects 30-56.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more memories; and
one or more processors, coupled to the one or more memories, configured to:
access a serving network via a satellite while in a first state with the serving network, the first state comprising a connected state;
transmit, to the serving network and based on a determination that a coverage gap associated with the satellite is upcoming, a coverage gap indication that indicates that the coverage gap is upcoming; and
transition from the connected state to a second state at or before a start of the coverage gap.

2. The UE of claim 1, wherein transmitting the coverage gap indication comprises transmitting the coverage gap indication to a radio access network (RAN) node of the serving network.

3. The UE of claim 1, wherein the RAN node comprises a satellite-based node.

4. The UE of claim 3, wherein transmitting the coverage gap indication comprises transmitting the coverage gap indication to a core network node of the serving network.

5. The UE of claim 3, wherein the core network node comprises an access and mobility management function (AMF).

6. The UE of claim 5, wherein transmitting the coverage gap indication comprises transmitting a non-access stratum (NAS) layer message including the coverage gap indication.

7. The UE of claim 1, wherein the one or more processors are further configured to receive configuration information, wherein the one or more processors, to transmit the coverage gap indication, are configured to transmit the coverage gap indication based on receiving the configuration information.

8. The UE of claim 7, wherein the configuration information comprises a configuration support indication that indicates that the serving network supports receiving the coverage gap indication.

9. The UE of claim 7, wherein the configuration information indicates that a value of a UE timer comprises a value selected by the UE, wherein the value selected by the UE is equal to zero, and wherein the one or more processors are further configured to refrain from starting the UE timer based on the value selected by the UE being equal to zero.

10. The UE of claim 7, wherein the one or more processors are further configured to start a UE timer while transmitting the coverage gap indication or after transmitting the coverage gap indication.

11. The UE of claim 10, wherein a duration of the UE timer is set to one of a UE timer value provided by the serving network or a UE timer value selected by the UE.

12. The UE of claim 11, wherein the UE timer value provided by the serving network is included in the configuration information and comprises a UE timer value, a UE timer range, or an indication of a selectable UE timer value.

13. The UE of claim 12, wherein a duration of the UE timer is set to one of the UE timer value when the configuration information is indicative of the UE timer value, a value within the UE timer range when the configuration information is indicative of the UE timer range, or a value selected by the UE when the configuration information is indicative of the selectable UE timer value or an indication that the UE timer value is zero.

14. The UE of claim 13, wherein the UE timer value selected by the UE is equal to zero.

15. The UE of claim 13, wherein the one or more processors are further configured to determine that the duration of the UE timer has expired or is set to zero, and wherein the one or more processors, to transition from the connected state to the second state, are configured to transition from the connected state to the second state based on determining that the duration of the UE timer has expired or is set to zero.

16. The UE of claim 10, wherein the one or more processors are further configured to transmit the coverage gap indication based on a difference between a duration of the UE timer and a time remaining until a start of the coverage gap associated with the satellite satisfying a threshold time value.

17. The UE of claim 10, wherein the one or more processors are further configured to transmit an indication of a duration of the UE timer.

18. The UE of claim 10, wherein the one or more processors are further configured to receive a connection release command prior to an expiration of a duration of the UE timer.

19. The UE of claim 7, wherein the configuration information indicates the second state.

20. The UE of claim 1, wherein the one or more processors, to transmit the coverage gap indication, are configured to transmit a medium access control (MAC) layer communication that includes the coverage gap indication, a radio resource control (RRC) layer message that includes the coverage gap indication, or a non-access stratum (NAS) layer message and the coverage gap indication.

21. The UE of claim 1, wherein the coverage gap indication comprises a release assistance indication.

22. The UE of claim 1, wherein the second state comprises an idle state, a suspended state, or an inactive state.

23. The UE of claim 1, wherein the one or more processors are further configured to enter a power saving state based on transitioning from the connected state to the second state.

24. The UE of claim 23, wherein the one or more processors, to enter the power saving state, are configured to deactivate at least one of a transceiver function, a network search function, or a paging monitoring function.

25. The UE of claim 1, wherein the one or more processors, to transition from the connected state to the second state, are configured to suspend or inactivating a signaling connection between the UE and the RAN node.

26. The UE of claim 25, wherein the second state comprises a suspended state, and wherein the suspended state comprises an idle state associated with a suspend indication.

27. The UE of claim 25, wherein the second state comprises an inactive state, and wherein the inactive state comprises a connected state to the serving network associated with a radio resource control inactive state.

28. The UE of claim 25, wherein the one or more processors are further configured to transition, based on a resume procedure, from the second state to the connected state based on a determination of an end of the coverage gap.

29. A network node for wireless communication, comprising:
one or more memories; and
one or more processors, coupled to the one or more memories, configured to:
receive, from a user equipment (UE) while the UE is in a first state with a serving network, a coverage gap indication that indicates that a coverage gap associated with a satellite via which the UE accesses the serving network is upcoming, the first state comprising a connected state; and
transition the UE to a second state at or before a start of the coverage gap.

30. The network node of claim 25, wherein the one or more processors are further configured to transmit configuration information, and wherein the one or more processors, to receive the coverage gap indication, are configured to receive the coverage gap indication based on the configuration information.
